(19) United States
(12) Patent Application Publication
(10) Pub. No.: US 2026/0264403 A1
(43) Pub. Date: Sep. 10, 2026

(54) LIQUID EJECTION HEAD SUBSTRATE AND METHOD FOR MANUFACTURING LIQUID EJECTION HEAD SUBSTRATE

(71) Applicant: CANON KABUSHIKI KAISHA, Tokyo (JP)

(72) Inventors: YUKI KOMORI, Tokyo (JP); MANABU OTSUKA, Kanagawa (JP); RYOTARO MURAKAMI, Kanagawa (JP)

(21) Appl. No.: 19/558,020

(22) Filed: Mar. 5, 2026

(30) Foreign Application Priority Data
Mar. 7, 2025 (JP) 2025-036702

(51) Int. Cl. B41J 2/14; B41J 2/16

(52) U.S. Cl. CPC B41J 2/1433; B41J 2/14233; B41J 2/162; B41J 2/1623; B41J 2/1628; B41J 2/1642; B41J 2202/03

(57) ABSTRACT

A liquid ejection head substrate includes a nozzle substrate having a nozzle for ejecting liquid. The nozzle substrate includes a substrate in which the nozzle is formed, a first film provided on a first surface of the substrate on a side from which the liquid is ejected from the nozzle, and a second film provided on a second surface of the substrate opposite to the first surface. A compressive stress or tensile stress similar to a compressive stress or tensile stress generated in the first film is generated in the second film.

### BACKGROUND

### Field of the Technology

The present disclosure relates to a liquid ejection head substrate and a method for manufacturing the liquid ejection head substrate.

### Description of the Related Art

Liquid ejection apparatuses such as inkjet printers include a liquid ejection head that ejects liquid such as ink. The liquid ejection head includes, for example, a nozzle substrate, a flow path substrate, a common liquid chamber, and a pitch conversion member. The nozzle substrate includes nozzles for ejecting ink. It should be noted that nozzles are also referred to as ejection ports. The flow path substrate is a substrate for supplying ink to the nozzles of the nozzle substrate. The common liquid chamber supplies ink to individual supply paths of the flow path substrate. The pitch conversion member supplies ink to the common liquid chamber. As a liquid-ejection-head substrate including the nozzle substrate and the flow path substrate as described above, for example, a liquid ejection head substrate described in Japanese Patent Laid-Open No. 2023-148382 (Literature 1) is known.

In the liquid ejection head substrate described in Literature 1, it is required to reduce the flow path resistance of ink in the nozzles. In a case where the nozzle substrate is made thinner to reduce the flow path resistance of the ink in the nozzles, there is a possibility that the reliability regarding the strength of the nozzle substrate is decreased due to the stress generated in the nozzle substrate.

### SUMMARY

The present disclosure is directed to improving reliability regarding the strength of a nozzle substrate.

A liquid ejection head substrate according to one aspect of the present disclosure is a liquid ejection head substrate including a nozzle substrate having a nozzle for ejecting liquid. The nozzle substrate includes a substrate on which the nozzle is formed, a first film provided on a first surface of the substrate on a side from which liquid is ejected from the nozzle, and a second film provided on a second surface of the substrate opposite to the first surface. A compressive stress or tensile stress similar to a compressive stress or tensile stress generated in the first film is generated in the second film.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view schematically illustrating a liquid ejection apparatus;

FIGS. 2A to 2C are explanatory diagrams illustrating a comparative example of an element substrate in a liquid ejection head;

FIGS. 3A to 3C are explanatory diagrams illustrating an element substrate according to a first embodiment;

FIG. 4 is a flowchart illustrating manufacturing processes of the element substrate according to the first embodiment;

FIGS. 5A to 5C are explanatory diagrams illustrating manufacturing processes of the element substrate according to the first embodiment;

FIGS. 6A and 6B are explanatory diagrams illustrating manufacturing processes of the element substrate according to the first embodiment;

FIGS. 7A to 7C are explanatory diagrams illustrating manufacturing processes of the element substrate according to the first embodiment;

FIGS. 8A to 8D are explanatory diagrams illustrating an element substrate according to a second embodiment;

FIG. 9 is a flowchart illustrating manufacturing processes of the element substrate according to the second embodiment;

FIGS. 10A to 10C are explanatory diagrams illustrating manufacturing processes of the element substrate according to the second embodiment;

FIGS. 11A and 11B are explanatory diagrams illustrating manufacturing processes of the element substrate according to the second embodiment;

FIGS. 12A and 12B are explanatory diagrams illustrating manufacturing processes of the element substrate according to the second embodiment;

FIGS. 13A to 13C are explanatory diagrams illustrating manufacturing processes of the element substrate according to the second embodiment; and

FIG. 14 is a plan cross-sectional view illustrating a part of the nozzle substrate.

### DESCRIPTION OF THE EMBODIMENTS

Hereinafter, preferred embodiments of the present disclosure will be described in detail with reference to the accompanying drawings. It should be noted that the following embodiments do not limit the matters of the present disclosure, and not all combinations of features described in the following embodiments are necessarily essential to the solutions of the present disclosure. It should be noted that the same components will be described by being designated with the same numerals.

### First Embodiment

### <Configuration of Liquid Ejection Apparatus>

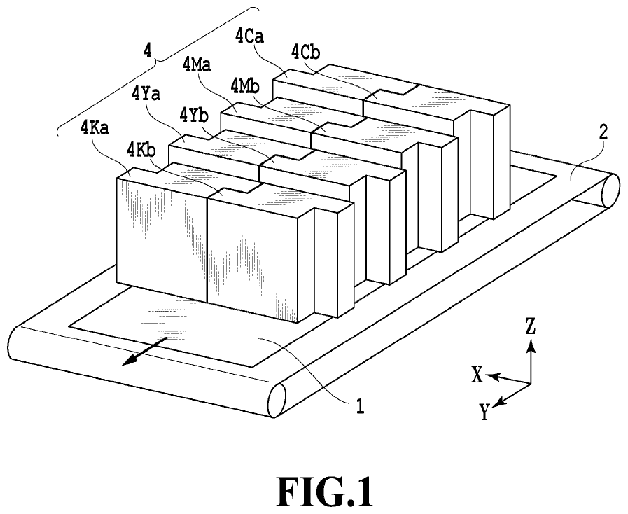

FIG. 1 is a perspective view schematically illustrating a part of a liquid ejection apparatus that is not illustrated. The liquid ejection apparatus in this embodiment is a one-pass type liquid ejection apparatus that prints an image by moving a print medium 1 once. The liquid ejection apparatus includes liquid ejection heads 4 as a full-line head in which element substrates each having nozzles (ejection ports) for ejecting liquid are arranged across the side corresponding to the entire width of the print medium 1. The print medium 1 is conveyed in the direction of an arrow (+Y direction) by conveyance unit 2, and printing is performed by the liquid ejection heads 4. It should be noted that in each figure referred to in the following, a Z direction represents the vertical direction, and intersects with (in this embodiment, orthogonal to) an X-Y plane defined by an X direction and a Y direction. The liquid ejection heads 4 in this embodiment can be implemented in an arbitrary form including the example illustrated in FIG. 1. In the example illustrated in FIG. 1, the liquid ejection apparatus mounted with eight liquid ejection heads 4 (4Ka, 4Kb, 4Ya, 4Yb, 4Ma, 4Mb, 4Ca, and 4Cb) is illustrated. These eight liquid ejection heads 4 are positioned within the liquid ejection apparatus by a reference member.

As described above, the liquid ejection heads 4 of this embodiment are a one-pass type, so-called page-wide type head having a length corresponding to the width of the print medium 1. It should be noted that the width of the print medium 1 is the size in the direction (the X direction) perpendicular to the conveying direction of the print medium 1. The liquid ejection head may be a so-called serial type liquid ejection head that performs printing while scanning the liquid ejection heads across the print medium. As an example of a serial type liquid ejection head, there is a configuration mounted with one element substrate for black ink and one element substrate for color ink. As another example of a serial type liquid ejection head, there is a configuration in which several element substrates are arranged so that nozzles overlap in the arrangement direction of a nozzle array, and the width of the head is smaller than the print medium.

### COMPARATIVE EXAMPLE

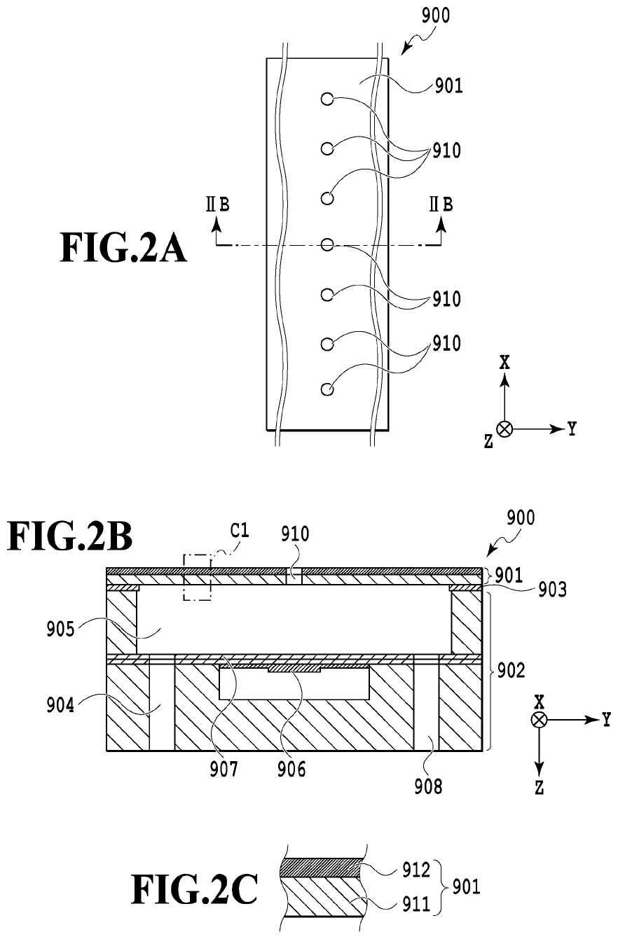

Next, a comparative example of an element substrate in a liquid ejection head will be described. FIGS. 2A to 2C are explanatory diagrams illustrating a comparative example of an element substrate in a liquid ejection head. FIG. 2A is a plan view illustrating the comparative example of the element substrate in the liquid ejection head. FIG. 2B is a cross-sectional view taken along IIB-IIB in FIG. 2A. FIG. 2C is an enlarged view of the portion surrounded by a frame C1 in FIG. 2B.

As illustrated in FIGS. 2A and 2B, an element substrate 900 in the comparative example includes a nozzle substrate 901 having a plurality of nozzles 910, and a flow path substrate 902 having an individual supply flow path 904 and an individual collecting flow path 908. The nozzle substrate 901 and the flow path substrate 902 are bonded together with an adhesive agent 903. The element substrate 900 in the comparative example is provided with a pressure chamber 905, a piezoelectric element 906, and a vibration plate 907. In the element substrate 900 as described above, the piezoelectric element 906 vibrates the vibration plate 907, so that the ink (liquid) in the pressure chamber 905 is ejected from the nozzles 910. Hereinafter, the side of the nozzle substrate from which the ink is ejected from the nozzles may be referred to as the ejecting side.

In the nozzle substrate 901 in the comparative example, in order to reduce the flow path resistance of the ink in the nozzles 910, the length of the nozzles 910 in the ink ejecting direction (the Z direction) may be shortened. As a method for shortening the length of the nozzles 910 in the ink ejecting direction, it is conceivable to make the nozzle substrate 901 thinner.

In addition, a film may be formed on the nozzle substrate 901 in the comparative example. For example, as illustrated in FIG. 2C, the nozzle substrate 901 includes a substrate 911 and a film 912. The substrate 911 is formed by using, for example, Si. The film 912 is provided on a surface of the substrate 911 on the ejecting side. The film 912 is formed by using, for example, SiO₂. The nozzles 910 are formed in the substrate 911 and the film 912. By providing the film 912 on the surface of the substrate 911 on the ejecting side, it is possible to suppress variations in the diameters of the nozzles 910, and to improve the ejecting stability of the ink.

In a case where the film 912 is provided on the surface of the substrate 911 on the ejecting side, stress is generated in the nozzle substrate 901 due to the difference between the coefficient of linear expansion of the film 912 and the coefficient of linear expansion of the substrate 911. In addition, stress is generated in the nozzle substrate 901 due to pressure fluctuations generated by the piezoelectric element 906 (energy generating element) arranged on the nozzle substrate 901. Therefore, in a case where the nozzle substrate 901 becomes thinner, there is a possibility that the reliability regarding the strength of the nozzle substrate 901 is decreased due to the stress generated in the nozzle substrate 901.

### <Configuration of Element Substrate>

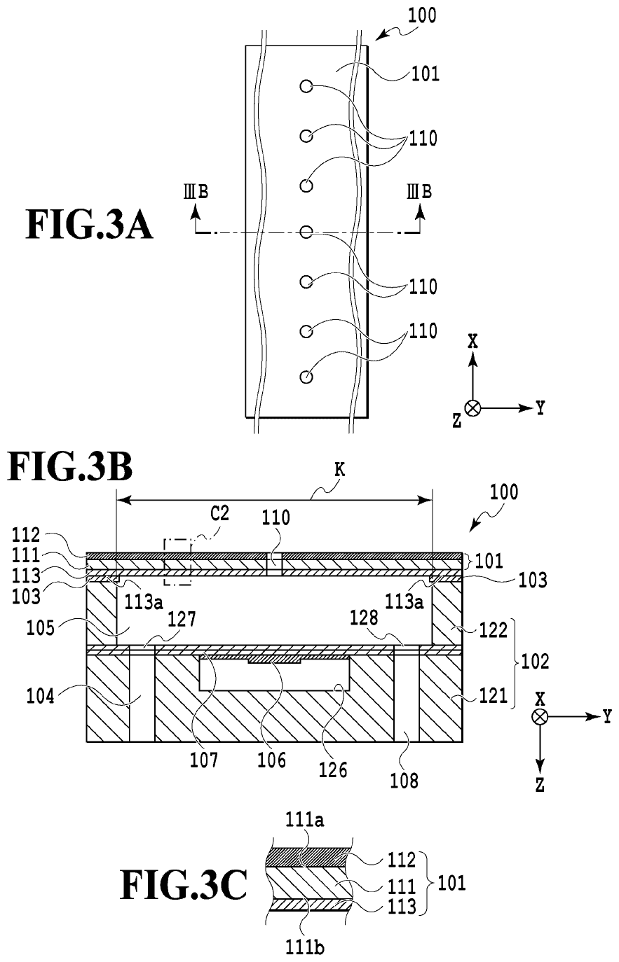

Next, the first embodiment of the element substrate, which is a liquid ejection head substrate, will be described. In this embodiment, a configuration capable of improving the reliability regarding the strength of the nozzle substrate will be described. FIGS. 3A to 3C are explanatory diagrams illustrating an element substrate 100 according to the first embodiment. FIG. 3A is a plan view illustrating the element substrate 100 according to the first embodiment. FIG. 3B is a cross-sectional view taken along IIIB-IIIB in FIG. 3A. FIG. 3C is an enlarged view of the portion surrounded by a frame C2 in FIG. 3B.

As illustrated in FIGS. 3A and 3B, the element substrate 100 according to the first embodiment includes a nozzle substrate 101 having a plurality of nozzles 110, and a flow path substrate 102 having an individual supply flow path 104 and an individual collecting flow path 108. The nozzle substrate 101 and the flow path substrate 102 are joined together by an adhesive agent 103. The element substrate 100 is provided with a pressure chamber 105, a piezoelectric element 106, and a vibration plate 107. In the element substrate 100 described above, the piezoelectric element 106 vibrates the vibration plate 107, so that the ink (liquid) in the pressure chamber 105 is ejected from the nozzles 110. The thickness of the nozzle substrate 101 in the ink ejecting direction (the Z direction) is preferably 40 [μm] or less. In addition, the thickness of the nozzle substrate 101 in the ink ejecting direction is more preferably 25 [μm] or less. Accordingly, the flow path resistance of the ink in the nozzles 110 can be reduced. It should be noted that the thickness of the nozzle substrate 101 in the ink ejecting direction may be 3 [μm] or more.

As illustrated in FIGS. 3B and 3C, the nozzle substrate 101 includes a substrate 111, a first film 112, and a second film 113. The substrate 111 is formed by using, for example, Si. The first film 112 is provided on a first surface 111a (a surface on the ejecting side) of the substrate 111 on the side from which ink is ejected from the nozzles 110. The first film 112 in the first embodiment is a single-layer film. The first film 112 may be a film including a plurality of layers of materials that are different from each other. The first film 112 is formed by using at least one of SiO₂, SiC, TaO, and perfluoropolyether (PFPE). For example, the first film 112 may be formed by using SiO₂, SiC, TaO, or the like by a film formation method such as thermal oxidation, CVD (chemical vapor deposition), or ALD (atomic layer deposition). The first film 112 may be formed by using a liquid-repellent film containing perfluoropolyether (PFPE).

The second film 113 is provided on a second surface 111b of the substrate 111 opposite to the first surface 111a. The plurality of nozzles 110 are formed to penetrate the first film 112, the substrate 111, and the second film 113 in the Z direction. The plurality of nozzles 110 are arranged side by side in the X direction in the nozzle substrate 101. It should be noted that the first film 112 and the second film 113 are not arranged on the first surface 111a and the second surface 111b of the substrate 111 in the portions where the nozzles 110 are formed. The second film 113 in the first embodiment is a single-layer film. The second film 113 may be a film including a plurality of layers of materials that are different from each other. Similar to the first film 112, the second film 113 is formed by using at least one of SiO₂, SiC, TaO, and perfluoropolyether (PFPE). It should be noted that the second film 113 may be formed by using a material different from that of the first film 112.

In addition, a bonding interface 113a is formed near an outer periphery portion of the second film 113. The flow path substrate 102 is bonded to the bonding interface 113a with the adhesive agent 103. The components of the adhesive agent 103 include at least one of epoxy resin, acrylic resin, silicone resin, benzocyclobutene resin, polyamide resin, polyimide resin, and urethane resin. For example, the adhesive agent 103 may be an epoxy resin adhesive agent, an acrylic resin adhesive agent, or a modified silicone resin adhesive agent.

The flow path substrate 102 is a substrate for supplying ink to the nozzles 110. The flow path substrate 102 includes a first flow path substrate 121 and a second flow path substrate 122. The first flow path substrate 121 and the second flow path substrate 122 are bonded together with an adhesive agent. The individual supply flow path 104, the individual collecting flow path 108, and a depressed portion 126 are formed in the first flow path substrate 121. The piezoelectric element 106 is accommodated in the depressed portion 126. A plurality of piezoelectric elements 106 and a vibration plate 107 are formed on the second flow path substrate 122. The plurality of piezoelectric elements 106 are provided so as to correspond to the plurality of nozzles 110. The pressure chamber 105 is formed between the second film 113 on the nozzle substrate 101 and the vibration plate 107 on the second flow path substrate 122. The pressure chamber 105 communicates with the nozzles 110. An individual supply port 127 and an individual collecting port 128 are formed in the vibration plate 107. The individual supply port 127 communicates with the individual supply flow path 104 and the pressure chamber 105. The individual collecting port 128 communicates with the individual collecting flow path 108 and the pressure chamber 105.

The ink (liquid) sent from a liquid supply unit (not illustrated) to the individual supply flow path 104 of the element substrate 100 flows into the pressure chamber 105 through the individual supply flow path 104 and the individual supply ports 127. As described above, the piezoelectric element 106 vibrates the vibration plate 107, so that the ink in the pressure chamber 105 is ejected from the nozzles 110. The ink that has not been ejected from the nozzle 110 of the ink in the pressure chamber 105 passes through the individual collecting port 128 and the individual collecting flow path 108 and is sent again to the individual supply flow path 104. In this manner, the ink supplied to the nozzles 110 circulates via the pressure chamber 105.

In a region K of the nozzle substrate 101 that overlaps with the pressure chamber 105, a compressive stress or tensile stress similar to a compressive stress or tensile stress generated in the first film 112 is generated in the second film 113. It should be noted that the term “similar” means that in a case where the stress generated in the first film 112 is a compressive stress, the stress generated in the second film 113 is also a compressive stress, and in a case where the stress generated in the first film 112 is a tensile stress, the stress generated in the second film 113 is also a tensile stress. For example, in a case where the first film 112 is a compressive film that pulls both end sides of the substrate 111 in the −Z direction, the second film 113 is formed to be a compressive film that pulls both end sides of the substrate 111 in the +Z direction. In other words, in a case where a compressive stress based on the difference between the coefficient of linear expansion of the first film 112 and the coefficient of linear expansion of the substrate 111 is generated in the first film 112, a compressive stress based on the difference between the coefficient of linear expansion of the second film 113 and the coefficient of linear expansion of the substrate 111 is to be generated in the second film 113. In a case where the first film 112 is a tensile film that presses both end sides of the substrate 111 in the +Z direction, the second film 113 is formed to be a tensile film that presses both end sides of the substrate 111 in the −Z direction. In other words, in a case where a tensile stress based on the difference between the coefficient of linear expansion of the first film 112 and the coefficient of linear expansion of the substrate 111 is generated in the first film 112, a tensile stress based on the difference between the coefficient of linear expansion of the second film 113 and the coefficient of linear expansion of the substrate 111 is to be generated in the second film 113. Accordingly, the force (for example, the tension) applied from the first film 112 to the substrate 111 can be offset by the force (for example, the tension) applied from the second film 113 to the substrate 111. Therefore, it is possible to suppress the stress generated in the region K of the nozzle substrate 101 that overlaps with the pressure chamber 105, and it is possible to improve the reliability regarding the strength of the nozzle substrate 101.

The relationship between the force applied from the first film 112 to the substrate 111 and the force applied from the second film 113 to the substrate 111 is preferably expressed by the following formula (1).

0.5<F1/F2<2 (1)
where F1: the magnitude of the force applied from the first film 112 to the substrate 111
F2: The magnitude of the force applied from the second film 113 to the substrate 111

By satisfying the formula (1), the difference between the force (for example, the tension) applied from the first film 112 to the substrate 111 and the force (for example, the tension) applied from the second film 113 to the substrate 111 becomes small. Therefore, it is possible to suppress the stress generated in the region K of the nozzle substrate 101 that overlaps with the pressure chamber 105, and it is possible to improve the reliability regarding the strength of the nozzle substrate 101. It should be noted that in a case where the magnitude of the force applied from the first film 112 to the substrate 111 is equal to or more than twice the magnitude of the force applied from the second film 113 to the substrate 111, the difference between the force applied from the first film 112 to the substrate 111 and the force applied from the second film 113 to the substrate 111 becomes large. In addition, in a case where the magnitude of the force applied from the first film 112 to the substrate 111 is equal to or less than 0.5 times the magnitude of the force applied from the second film 113 to the substrate 111, the difference between the force applied from the first film 112 to the substrate 111 and the force applied from the second film 113 to the substrate 111 becomes large. Therefore, the stress generated in the region K of the nozzle substrate 101 that overlaps with the pressure chamber 105 is increased, and there is a possibility that the reliability regarding the strength of the nozzle substrate 101 is decreased.

In addition, the relationship between the force applied from the first film 112 to the substrate 111 and the force applied from the second film 113 to the substrate 111 is preferably expressed by the following formula (2).

|F1−F2|<=100 [N/m] (2)
where F1: the magnitude of the force applied from the first film 112 to the substrate 111
F2: The magnitude of the force applied from the second film 113 to the substrate 111

By satisfying the formula (2), the difference between the force (for example, the tension) applied from the first film 112 to the substrate 111 and the force (for example, the tension) applied from the second film 113 to the substrate 111 becomes small. Therefore, it is possible to suppress the stress generated in the region K of the nozzle substrate 101 that overlaps with the pressure chamber 105, and it is possible to improve the reliability regarding the strength of the nozzle substrate 101. In addition, the lower limit of the formula (2) may be 0 or more.

In a case where the first film 112 is a single-layer film, the magnitude of the force applied from the first film 112 to the substrate 111 can be calculated based on the product of the stress generated in the first film 112 and the thickness of the first film 112. In a case where the second film 113 is a single-layer film, the magnitude of the force applied from the second film 113 to the substrate 111 can be calculated based on the product of the stress generated in the second film 113 and the thickness of the second film 113. As described above, the first film 112 may be a film including a plurality of layers of materials that are different from each other. In this case, the magnitude of the force applied from the first film 112 to the substrate 111 can be calculated based on the sum of the products of the stress generated in each layer of the first film 112 and the thickness of each layer of the first film 112. In addition, the second film 113 may also be a film including a plurality of layers of materials that are different from each other. In this case, the magnitude of the force applied from the second film 113 to the substrate 111 can be calculated based on the sum of the products of the stress generated in each layer of the second film 113 and the thickness of each layer of the second film 113.

As described above, the second film 113 includes the bonding interface 113a to which the flow path substrate 102 is bonded with the adhesive agent 103. By reducing the difference between the force applied from the first film 112 to the substrate 111 and the force applied from the second film 113 to the substrate 111, the reliability regarding the adhesion of the flow path substrate 102 to the bonding interface 113a of the nozzle substrate 101 (the second film 113) can be improved.

### EMBODIMENTS

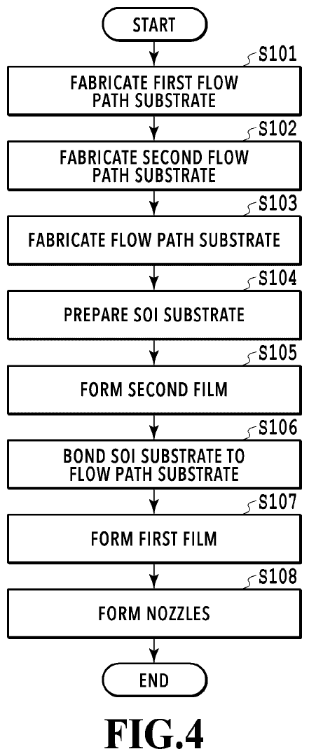

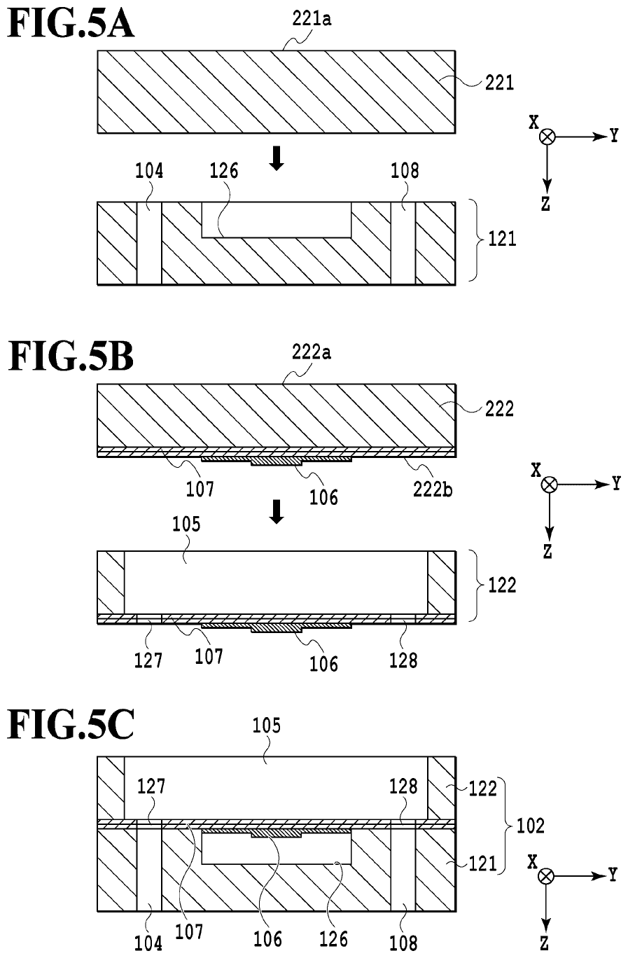

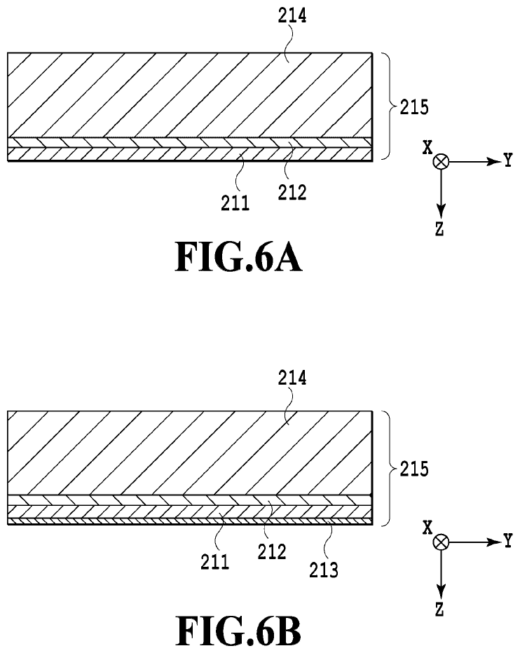

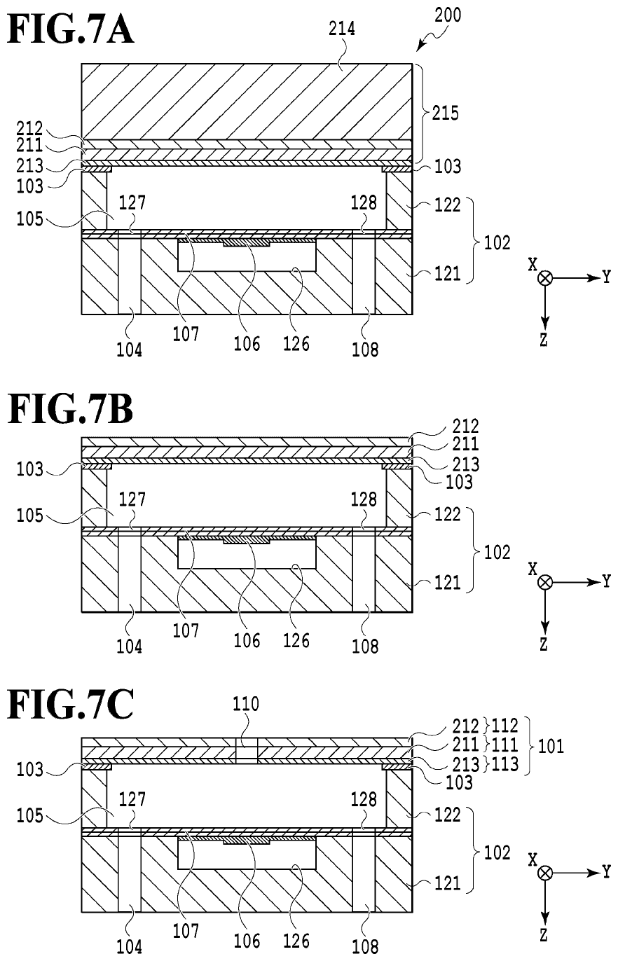

Next, an example of the element substrate 100 according to the first embodiment and a manufacturing method thereof will be described. FIG. 4 is a flowchart illustrating manufacturing processes of the element substrate 100 according to the first embodiment. FIGS. 5A to 5C, FIGS. 6A and 6B, and FIGS. 7A to 7C are explanatory views illustrating manufacturing processes of the element substrate 100 according to the first embodiment. FIG. 5A is an explanatory diagram illustrating a process of fabricating the first flow path substrate 121. FIG. 5B is an explanatory diagram illustrating a process of fabricating the second flow path substrate 122. FIG. 5C is an explanatory diagram illustrating a process of fabricating the flow path substrate 102. FIG. 6A is an explanatory diagram illustrating a process of preparing an SOI substrate 215. FIG. 6B is an explanatory diagram illustrating a process of forming the second film 113 (an SiC layer 213). FIG. 7A is an explanatory diagram illustrating a process of bonding the SOI substrate 215 and the flow path substrate 102 together. FIG. 7B is an explanatory diagram illustrating a process of forming the first film 112. FIG. 7C is an explanatory diagram illustrating a process of forming the nozzle 110.

First, in step S101 of FIG. 4, the first flow path substrate 121 was fabricated. As illustrated in FIG. 5A, in the process of fabricating the first flow path substrate 121, an Si substrate 221 was prepared. The thickness of the Si substrate 221 is 600 [μm]. A photoresist was formed as a mask on one surface 221a of the Si substrate 221, and dry etching was performed by the Bosch process. After the dry etching was performed, the photoresist was peeled off to fabricate the first flow path substrate 121 having the individual supply flow path 104, the individual collecting flow path 108, and the depressed portion 126.

Next, in step S102 of FIG. 4, the second flow path substrate 122 was fabricated. As illustrated in FIG. 5B, in the process of fabricating the second flow path substrate 122, a piezoelectric element substrate 222 having a piezoelectric element 106 and a vibration plate 107 was prepared. A photoresist was formed as a mask on a surface 222a of the piezoelectric element substrate 222 opposite to the piezoelectric element 106 and a surface 222b of the piezoelectric element substrate 222 on the vibration plate 107 side, and dry etching was performed by the Bosch process. After the dry etching was performed, the photoresist was peeled off to fabricate the second flow path substrate 122 having the pressure chamber 105, the individual supply port 127, and the individual collecting port 128.

Next, in step S103 of FIG. 4, the first flow path substrate 121 and the second flow path substrate 122 were joined together to fabricate the flow path substrate 102. As illustrated in FIG. 5C, in the process of fabricating the flow path substrate 102, the first flow path substrate 121 and the second flow path substrate 122 were bonded together using an epoxy resin adhesive agent. In a case where the first flow path substrate 121 and the second flow path substrate 122 were joined together, the first flow path substrate 121 and the second flow path substrate 122 were heated and pressurized.

Next, in step S104 of FIG. 4, the SOI (Silicon On Insulator) substrate 215 (refer to FIG. 6A) was prepared. As illustrated in FIG. 6A, the SOI substrate 215 includes a first Si layer 214, a SiO₂ layer 212, and a second Si layer 211. The first Si layer 214 and the second Si layer 211 are layers formed by using Si. The SiO₂ layer 212 is a layer formed by using SiO₂. The thickness of the first Si layer 214 is 500 [μm]. The thickness of the SiO₂ layer 212 is 0.5 [μm]. The thickness of the second Si layer 211 is 15 [μm].

Next, in step S105 of FIG. 4, the second film 113 (refer to FIG. 3B) was formed by forming the SiC layer 213 (refer to FIG. 6B) on the SOI substrate 215. The SiC layer 213 is a layer formed by using SiC. As illustrated in FIG. 6B, in the process of forming the second film 113 (the SiC layer 213), the SiC layer 213 was formed on a surface of the second Si layer 211 of the SOI substrate 215 by plasma CVD. The thickness of the SiC layer 213 is 0.1 [μm]. Accordingly, the second film 113, which is a single-layer film made of the SiC layer 213, was obtained.

Next, in step S106 of FIG. 4, the SOI substrate 215 and the flow path substrate 102 were bonded together by using the adhesive agent 103, so that a bonded substrate 200 (refer to FIG. 7A) was obtained. As illustrated in FIG. 7A, at the time of bonding the SOI substrate 215 and the flow path substrate 102 together, the SOI substrate 215 and the flow path substrate 102 were heated and pressurized. In addition, an epoxy resin adhesive agent was used as the adhesive agent 103.

Next, in step S107 of FIG. 4, the SiO₂ layer 212 of the SOI substrate 215 was exposed to form the first film 112 (refer to FIG. 3B). In the process of forming the first film 112, as illustrated in FIG. 7B, the first Si layer 214 of the SOI substrate 215 was removed to expose the SiO₂ layer 212. Accordingly, the first film 112, which is a single-layer film made of the SiO₂ layer 212, was obtained. In addition, the single-layer substrate 111 made of the second Si layer 211 was obtained.

Then, in step S108 of FIG. 4, the nozzles 110 (the ejection ports) were formed. As illustrated in FIG. 7C, in the process of forming the nozzles 110, a photoresist was formed as a mask on a surface of the SiO₂ layer 212, and dry etching was performed by the Bosch process. After the dry etching was performed, the photoresist was peeled off to form the nozzles 110.

With the above processes, the element substrate 100 (the liquid ejection head substrate) including the nozzle substrate 101 illustrated in FIG. 3B was obtained. In this example, in the region K of the nozzle substrate 101 that overlapped with the pressure chamber 105, the second film 113 that was a single-layer film made of the SiC layer 213 was formed on the opposite side of the nozzle substrate 101 to the first film 112. Accordingly, it became possible to offset the tension (the force pulling both end sides of the substrate 111) applied to the substrate 111 (the second Si layer 211) from the first film 112 (the SiO₂ layer 212), which was a compressive film, by the tension applied to the substrate 111 from the second film 113, which was a compressive film. In this example, the tension applied to the substrate 111 from the first film 112 was greater than the tension applied to the substrate 111 from the second film 113. Specifically, the magnitude of the tension applied from the first film 112 to the substrate 111 was less than twice the magnitude of the tension applied from the second film 113 to the substrate 111. Therefore, it was possible to suppress the stress generated in the region K of the nozzle substrate 101 that overlapped with the pressure chamber 105, and it was possible to improve the reliability regarding the strength of the nozzle substrate 101.

In a case where the first film 112 is a single-layer film, the magnitude of the tension applied from the first film 112 to the substrate 111 can be calculated based on the product of the compressive stress generated in the first film 112 and the thickness of the first film 112. In a case where the second film 113 is a single-layer film, the magnitude of the tension applied from the second film 113 to the substrate 111 can be calculated based on the product of the compressive stress generated in the second film 113 and the thickness of the second film 113. In this example, by satisfying the above-described formulas (1) and (2), it was possible to reduce the difference between the tension applied to the substrate 111 from the first film 112 and the tension applied to the substrate 111 from the second film 113.

In the above-described example, although the first film 112 is a compressive film made of the SiO₂ layer 212, and the second film 113 is a compressive film made of the SiC layer 213, the present invention is not limited to this. For example, in a case where the first film 112 is a tensile film, the second film 113 may be a tensile film. Accordingly, it becomes possible to offset the pressure force (the force pressing on both end sides of the substrate 111) applied to the substrate 111 from the first film 112, which is a tensile film, by the pressure force applied to the substrate 111 from the second film 113, which is a tensile film. In this case, the first film 112 may include a layer of a material different from that of the SiO₂ layer. The second film 113 may include a layer of a material different from that of the SiC layer 213. In a case where the first film 112 is a single-layer film, the magnitude of the pressing force applied from the first film 112 to the substrate 111 can be calculated based on the product of the tensile stress generated in the first film 112 and the thickness of the first film 112. In a case where the second film 113 is a single-layer film, the magnitude of the pressing force applied from the second film 113 to the substrate 111 can be calculated based on the product of the tensile stress generated in the second film 113 and the thickness of the second film 113.

In the above-described example, an epoxy resin adhesive agent is used as the adhesive agent 103, but the adhesive agent 103 is not limited to this. For example, as the adhesive agent 103, an acrylic resin adhesive agent may be used, or a modified silicone resin adhesive agent may be used. The components of the adhesive agent 103 may include at least one of epoxy resin, acrylic resin, silicone resin, benzocyclobutene resin, polyamide resin, polyimide resin, and urethane resin.

In the above-described example, the order of performing each process of the manufacturing processes of the element substrate 100 is not limited as long as the element substrate 100 can be manufactured. The order of performing each process of the manufacturing processes of the element substrate 100 may be changed as appropriate. Some processes of the manufacturing processes of the element substrate 100 may be performed simultaneously.

As described above, according to the first embodiment, the reliability regarding the strength of the nozzle substrate 101 can be improved. That is, in this embodiment, the first film 112 is provided on the first surface 111a of the substrate 111, and the second film 113 is provided on the second surface 111b of the substrate 111 opposite to the first surface 111a. A compressive stress or tensile stress similar to the compressive stress or tensile stress generated in the first film 112 is generated in the second film 113. Accordingly, since the force (for example, the tension) applied from the first film 112 to the substrate 111 can be offset by the force (for example, the tension) applied from the second film 113 to the substrate 111, the stress generated in the nozzle substrate 101 can be suppressed. In this manner, the reliability regarding the strength of the nozzle substrate 101 can be improved.

In the above-described first embodiment, in the region K of the nozzle substrate 101 that overlaps with the pressure chamber 105, although the compressive stress or tensile stress similar to the compressive stress or tensile stress generated in the first film 112 is generated in the second film 113, this is not a limitation. For example, in a part of the region K of the nozzle substrate 101 that overlaps with the pressure chamber 105, a compressive stress or tensile stress similar to the compressive stress or tensile stress generated in the first film 112 may be generated in the second film 113. In the region K of the nozzle substrate 101 that overlaps with the pressure chamber 105 and the region including the bonding interface 113a that is bonded to the flow path substrate 102, a compressive stress or tensile stress similar to the compressive stress or tensile stress generated in the first film 112 may be generated in the second film 113. Even in this manner, since the force (for example, the tension) applied from the first film 112 to the substrate 111 can be offset by the force (for example, the tension) applied from the second film 113 to the substrate 111, the stress generated in the nozzle substrate 101 can be suppressed.

### Second Embodiment

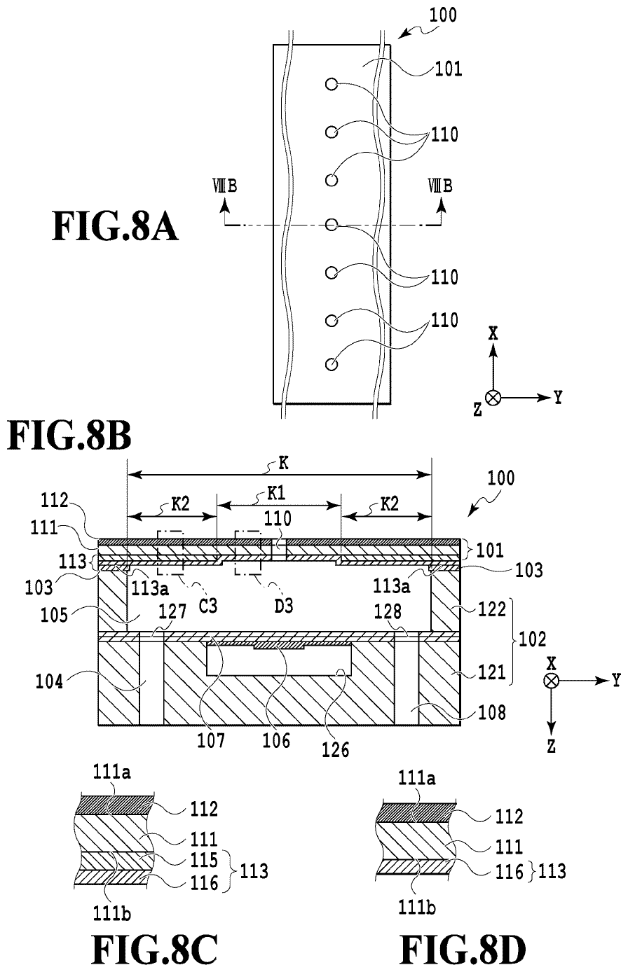

Next, a second embodiment of an element substrate that is a liquid ejection head substrate will be described. Individual members in the second embodiment have the same configurations as those in the above-described first embodiment, and thus will be described by using the same numerals as those of the respective members in the above-described first embodiment. FIGS. 8A to 8D are explanatory diagrams illustrating an element substrate 100 according to the second embodiment. FIG. 8A is a plan view showing the element substrate 100 according to the second embodiment. FIG. 8B is a cross-sectional view taken along line VIIIB-VIIIB in FIG. 8A. FIG. 8C is an enlarged view of the portion surrounded by a frame C3 in FIG. 8B. FIG. 8D is an enlarged view of the portion surrounded by a frame D3 in FIG. 8B.

As illustrated in FIGS. 8A and 8B, the element substrate 100 according to the second embodiment includes a nozzle substrate 101 having a plurality of nozzles 110, and a flow path substrate 102 having an individual supply flow path 104 and an individual collecting flow path 108. The nozzle substrate 101 and the flow path substrate 102 are bonded together by an adhesive agent 103. The element substrate 100 is provided with a pressure chamber 105, a piezoelectric element 106, and a vibration plate 107. In the element substrate 100 as described above, the piezoelectric element 106 vibrates the vibration plate 107, so that the ink (liquid) in the pressure chamber 105 is ejected from the nozzle 110. The thickness of the nozzle substrate 101 in the ink ejecting direction (the Z direction) is preferably 40 [μm] or less. In addition, the thickness of the nozzle substrate 101 in the ink ejecting direction is more preferably 25 [μm] or less. Accordingly, the flow path resistance of the ink in the nozzle 110 can be reduced. It should be noted that the thickness of the nozzle substrate 101 in the ink ejecting direction may be 3 [μm] or more.

The flow path substrate 102 in the second embodiment is formed similarly to the flow path substrate 102 in the first embodiment. Therefore, a detailed description of the flow path substrate 102 in the second embodiment is omitted.

As illustrated in FIGS. 8B to 8D, the nozzle substrate 101 includes a substrate 111, a first film 112, and a second film 113. The substrate 111 is formed by using, for example, Si. The first film 112 is provided on a first surface 111a (a surface on the ejection side) of the substrate 111 on the side from which ink is ejected from the nozzles 110. The second film 113 is provided on a second surface 111b of the substrate 111 opposite to the first surface 111a. The plurality of nozzles 110 are formed to penetrate the first film 112, the substrate 111, and the second film 113 in the Z direction. The plurality of nozzles 110 are arranged side by side in the X direction in the nozzle substrate 101.

In the second embodiment, a region K of the nozzle substrate 101 that overlaps with the pressure chamber 105 is provided with a proximity portion K1 that is in contact with the nozzle 110 and the other portion K2 other than the proximity portion K1. The thickness of the proximity portion (K1) of the second film 113 that is in contact with the nozzle 110 is smaller than the thickness of the other portion (K2) of the second film 113 other than the proximity portion (K1).

The first film 112 in the second embodiment is a film including a plurality of layers of materials that are different from each other. The first film 112 may be a single-layer film. The first film 112 in the second embodiment is formed by using at least one of SiO₂, SiC, TaO, and perfluoropolyether (PFPE), as in the first embodiment.

The second film 113 in the second embodiment is formed by using at least one of SiO₂, SiC, TaO, and perfluoropolyether (PFPE), as in the first embodiment. It should be noted that the second film 113 may be formed by using a material different from that of the first film 112. The second film 113 in the second embodiment includes, for example, a first layer 115 and a second layer 116. The first layer 115 is formed on a second surface 111b of the substrate 111 in the other portion K2 of the region K that overlaps with the pressure chamber 105 (refer to FIG. 8C). The second layer 116 is formed on the second surface 111b of the substrate 111 in the proximity portion K1 of the region K that overlaps with the pressure chamber 105 (refer to FIG. 8D). The second layer 116 is formed to overlap the first layer 115 in the other portion K2 of the region K that overlaps with the pressure chamber 105 (refer to FIG. 8C). As described above, the proximity portion (K1) of the second film 113 that is in contact with the nozzle 110 only includes the second layer 116. The other portion (K2) of the second film 113 includes the first layer 115 and the second layer 116. The number of layers forming the proximity portion (K1) of the second film 113 that is in contact with the nozzle 110 is less than the number of layers forming the other portion (K2) of the second film 113.

In addition, a bonding interface 113a is formed near an outer periphery of the second film 113. The flow path substrate 102 is bonded to the bonding interface 113a with an adhesive agent 103. As in the first embodiment, the components of the adhesive agent 103 include at least one of epoxy resin, acrylic resin, silicone resin, benzocyclobutene resin, polyamide resin, polyimide resin, and urethane resin. In the second embodiment, at least a part of the proximity portion (K1) of the second film 113 needs to be in contact with the nozzle 110. At least a part of the other portion (K2) of the second film 113 need be in contact with the bonding interface 113a. The surface area of the proximity portion (K1) of the second film 113 that is in contact with the nozzle 110 is preferably 10% or less of the surface area of the other portion (K2) of the second film 113. Accordingly, the reliability regarding the strength of the nozzle substrate 101 can be improved.

In the other portion K2 of the region K that overlaps with the pressure chamber 105, a compressive stress or tensile stress similar to the compressive stress or tensile stress generated in the first film 112 is generated in the layers (the first layer 115 and the second layer 116) forming the second film 113. Accordingly, the force (for example, the tension) applied from the first film 112 to the substrate 111 in the other portion K2 of the region K that overlaps with the pressure chamber 105 can be offset by the force (for example, the tension) applied from the second film 113 to the substrate 111. In addition, in the other portion K2 of the region K that overlaps with the pressure chamber 105, by satisfying the above-described formulas (1) and (2), the difference between the force applied from the first film 112 to the substrate 111 and the force applied from the second film 113 to the substrate 111 becomes small. Therefore, it is possible to suppress the stress generated in the other portion K2 of the region K of the nozzle substrate 101 that overlaps with the pressure chamber 105.

In the proximity portion K1 of the region K that overlaps with the pressure chamber 105, a compressive stress or tensile stress similar to the compressive stress or tensile stress generated in the first film 112 is generated in the layer (the second layer 116) forming the second film 113. Accordingly, the force (for example, the tension) applied from the first film 112 to the substrate 111 in the proximity portion K1 of the region K that overlaps with the pressure chamber 105 can be offset by the force (for example, the tension) applied from the second film 113 to the substrate 111. In addition, in the proximity portion K1 of the region K that overlaps with the pressure chamber 105, by satisfying the above-described formulas (1) and (2), the difference between the force applied from the first film 112 to the substrate 111 and the force applied from the second film 113 to the substrate 111 becomes small. Therefore, it is possible to suppress the stress generated in the proximity portion K1 of the region K that overlaps with the pressure chamber 105 in the nozzle substrate 101.

In the second embodiment, the thickness of the proximity portion (K1) of the second film 113 that is in contact with the nozzle 110 is smaller than the thickness of the other portion (K2) of the second film 113 other than the proximity portion (K1). Accordingly, since the proximity portion K1 of the region K of the nozzle substrate 101 that overlaps with the pressure chamber 105 becomes thinner, the length of the nozzles 110 in the ink ejecting direction (the Z direction) can be shortened. Therefore, according to the second embodiment, it is possible to improve the reliability regarding the strength of the nozzle substrate 101, and to reduce the flow path resistance of the ink in the nozzles 110.

In the above-described formulas (1) and (2), the magnitude of the force applied from the first film 112 to the substrate 111 and the magnitude of the force applied from the second film 113 to the substrate 111 can be calculated in a manner similar to that in the first embodiment. As described above, the first film 112 may be a film including a plurality of layers of materials that are different from each other. In this case, the magnitude of the force applied from the first film 112 to the substrate 111 can be calculated based on the sum of the products of the stress generated in each layer of the first film 112 and the thickness of each layer of the first film 112. In addition, the second film 113 may also be a film including a plurality of layers of materials that are different from each other. In this case, the magnitude of the force applied from the second film 113 to the substrate 111 can be calculated based on the sum of the products of the stress generated in each layer of the second film 113 and the thickness of each layer of the second film 113.

As described above, the second film 113 has the bonding interface 113a to which the flow path substrate 102 is bonded with the adhesive agent 103. By reducing the difference between the force applied from the first film 112 to the substrate 111 and the force applied from the second film 113 to the substrate 111, the reliability regarding the adhesion of the flow path substrate 102 to the bonding interface 113a of the nozzle substrate 101 (the second film 113) can be improved.

### EXAMPLES

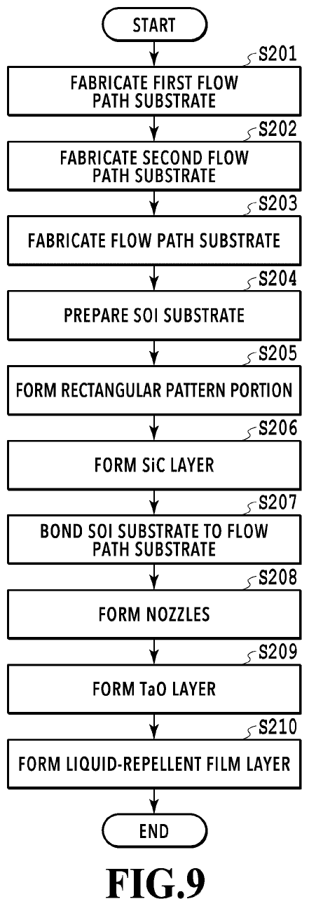

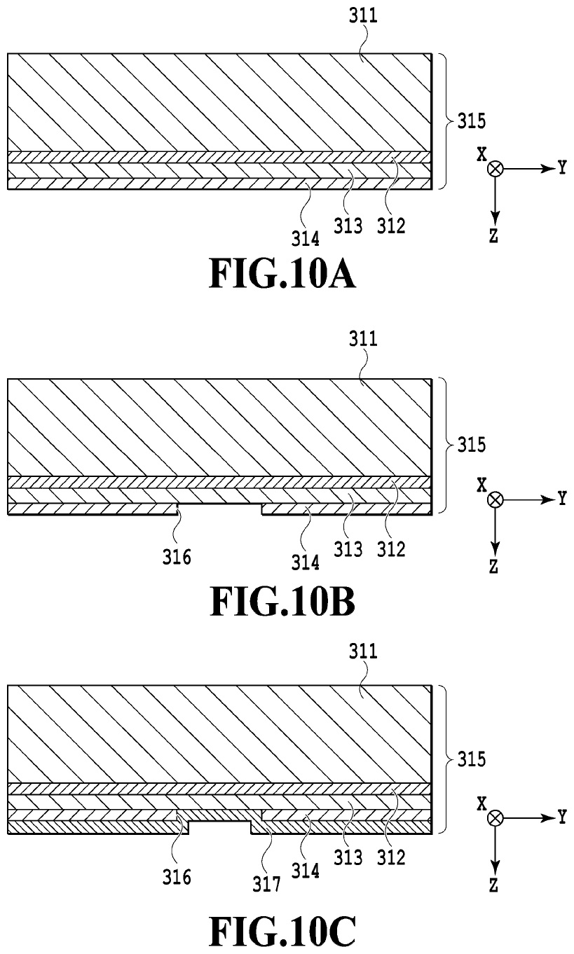

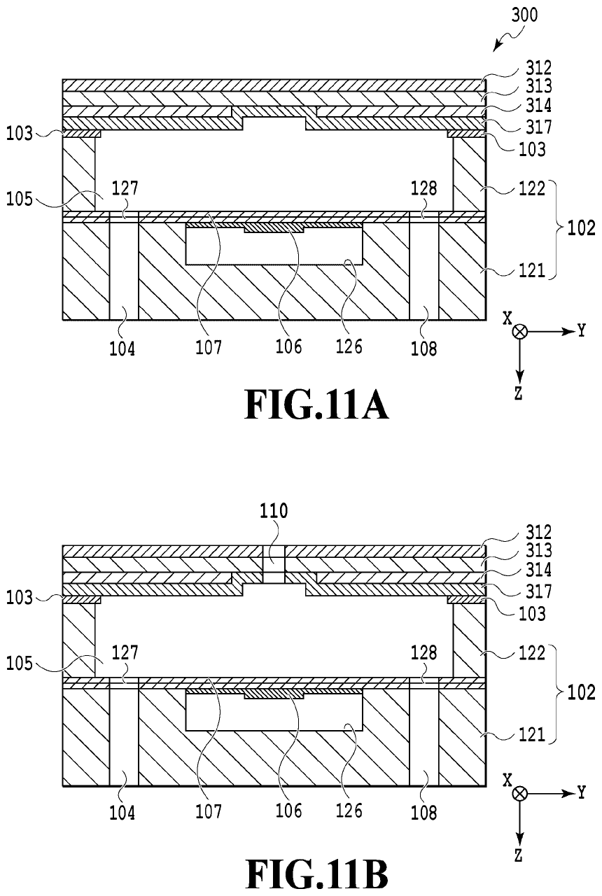

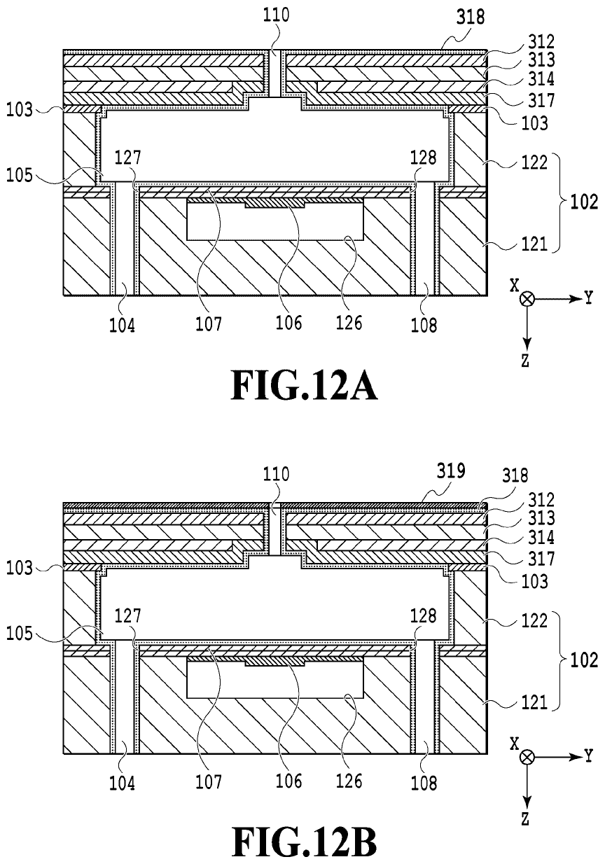

Next, examples of the element substrate 100 according to the second embodiment and a manufacturing method thereof will be described. FIG. 9 is a flowchart illustrating manufacturing processes of the element substrate 100 according to the second embodiment. FIGS. 10A to 10C, FIGS. 11A and 11B, and FIGS. 12A and 12B are explanatory diagrams illustrating manufacturing processes of the element substrate 100 according to the second embodiment. FIG. 10A is an explanatory diagram illustrating a process of preparing an SOI substrate 315. FIG. 10B is an explanatory diagram illustrating a process of forming a rectangular pattern portion 316. FIG. 10C is an explanatory diagram illustrating a process of forming an SiC layer 317. FIG. 11A is an explanatory diagram illustrating a process of bonding the SOI substrate 315 and the flow path substrate 102 together. FIG. 11B is an explanatory diagram illustrating a process of forming the nozzle 110. FIG. 12A is an explanatory diagram illustrating a process of forming a TaO layer 318. FIG. 12B is an explanatory diagram illustrating a process of forming a liquid-repellent film layer 319.

First, in step S201 of FIG. 9, the first flow path substrate 121 was fabricated as in the first embodiment. Next, in step S202 of FIG. 9, the second flow path substrate 122 was fabricated as in the first embodiment. Next, in step S203 of FIG. 9, the first flow path substrate 121 and the second flow path substrate 122 were bonded together to fabricate the flow path substrate 102, as in the first embodiment.

Next, in step S204 of FIG. 9, the SOI substrate 315 (refer to FIG. 10A) was prepared. As illustrated in FIG. 10A, the SOI substrate 315 includes a first Si layer 311, a first SiO₂ layer 312, a second Si layer 313, and a second SiO₂ layer 314. The first Si layer 311 and the second Si layer 313 are layers formed by using Si. The first SiO₂ layer 312 and the second SiO₂ layer 314 are layers formed by using SiO₂. The thickness of the first Si layer 311 is 500 [μm]. The thickness of the first SiO₂ layer 312 is 0.4 [μm]. The thickness of the second Si layer 313 is 15 [μm]. The thickness of the second SiO₂ layer 314 is 0.5 [μm].

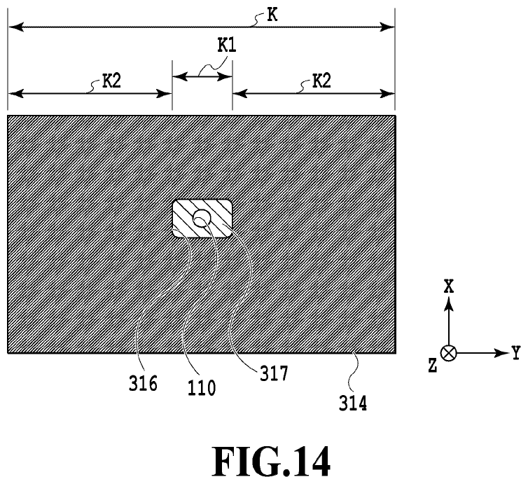

Next, in step S205 of FIG. 9, the rectangular pattern portion 316 (refer to FIG. 10B, and FIG. 14 that will be described later) in which the second SiO₂ layer 314 was not disposed was formed in the second SiO₂ layer 314. As illustrated in FIG. 10B, in the process of forming the rectangular pattern portion 316, a photoresist was applied to a surface of the second SiO₂ layer 314, and a rectangular pattern was exposed and developed. The size of the rectangular pattern is 50 [μm]×50 [μm]. After the rectangular pattern was exposed and developed, dry etching was performed to peel off the photoresist, so that the rectangular pattern portion 316 was formed in the second SiO₂ layer 314.

Next, in step S206 of FIG. 9, the SiC layer 317 (refer to FIG. 10C) was formed on the SOI substrate 315. The SiC layer 317 is a layer formed by using SiC. As illustrated in FIG. 10C, in the process of forming the SiC layer 317, the SiC layer 317 was formed on a surface of the second SiO₂ layer 314 of the SOI substrate 315 by plasma CVD. It should be noted that in the rectangular pattern portion 316 of the second SiO₂ layer 314, the SiC layer 317 is formed on a surface of the second Si layer 313 exposed through the rectangular pattern portion 316. The thickness of the SiC layer 317 is 0.03 [μm].

Next, in step S207 of FIG. 9, the SOI substrate 315 and the flow path substrate 102 were bonded together by using the adhesive agent 103 to obtain a bonded substrate 300 (refer to FIG. 11A). In a case where the SOI substrate 315 and the flow path substrate 102 were bonded together, the SOI substrate 315 and the flow path substrate 102 were heated and pressurized. In addition, an epoxy resin adhesive agent was used as the adhesive agent 103. As illustrated in FIG. 11A, after the SOI substrate 315 and the flow path substrate 102 were bonded together, the first Si layer 311 of the SOI substrate 315 was removed to expose the first SiO₂ layer 312. Accordingly, the single-layer substrate 111 made of the second Si layer 313 was obtained.

Next, in step S208 of FIG. 9, the nozzles 110 (the ejection ports) were formed. As illustrated in FIG. 11B, in the process of forming the nozzles 110, a photoresist was formed as a mask on a surface of the first SiO₂ layer 312, and dry etching was performed by the Bosch process. After the dry etching was performed, the photoresist was peeled off to form the nozzles 110.

Next, in step S209 of FIG. 9, the TaO layer 318 (refer to FIG. 12A) was formed. The TaO layer 318 is a layer formed by using TaO. As illustrated in FIG. 12A, in the process of forming the TaO layer 318, the TaO layer 318 was formed on surfaces of the first SiO₂ layer 312, the second SiO₂ layer 314, and the like by ALD (atomic layer deposition). The thickness of the TaO layer 318 is 20 [nm].

Then, in step S210 of FIG. 9, the liquid-repellent film layer 319 (refer to FIG. 12B) was formed. The liquid-repellent film layer 319 is a layer formed by using a liquid-repellent film. As illustrated in FIG. 12B, in the process of forming the liquid-repellent film layer 319, the liquid-repellent film layer 319 containing perfluoropolyether (PFPE) was formed on a surface of the TaO layer 318. The thickness of the liquid-repellent film layer 319 is 10 [nm].

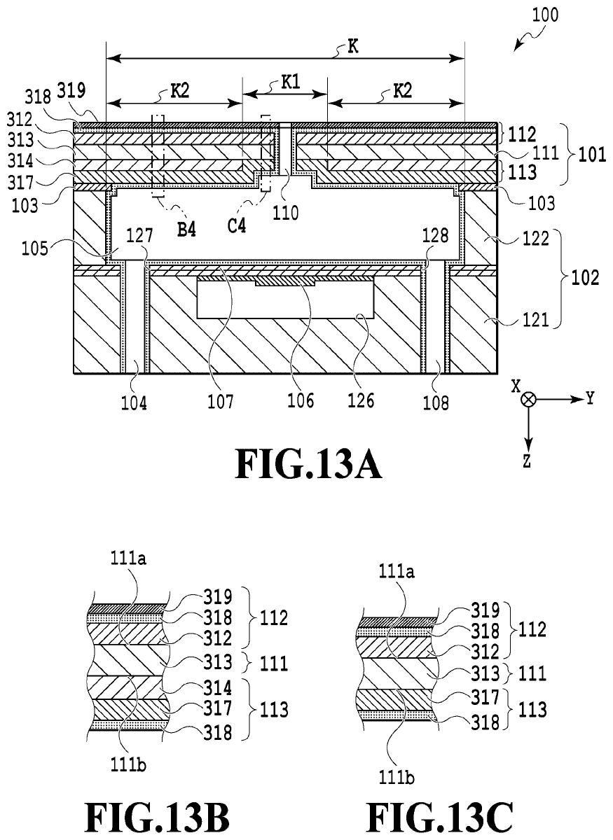

With the above processes, the element substrate 100 (the liquid ejection head substrate) including the nozzle substrate 101 illustrated in FIGS. 13A to 13C and FIG. 14 was obtained. FIGS. 13A to 13C are explanatory diagrams illustrating an example of the element substrate 100 according to the second embodiment. FIG. 13A is a side cross-sectional view illustrating the example of the element substrate 100 according to the second embodiment. FIG. 13B is an enlarged view of the portion surrounded by a frame B4 in FIG. 13A. FIG. 13C is an enlarged view of the portion surrounded by a frame C4 in FIG. 13A. FIG. 14 is a plan cross-sectional view illustrating a part of the nozzle substrate 101 in the second embodiment.

As illustrated in FIG. 13A, a region K of the nozzle substrate 101 that overlaps with the pressure chamber 105 is provided with a proximity portion K1 that is in contact with the nozzle 110 and the other portion K2 other than the proximity portion K1. As illustrated in FIGS. 13B and 13C, in the example of the element substrate 100 according to the second embodiment, the substrate 111 is a single-layer substrate made of the second Si layer 313. The first film 112 includes the first SiO₂ layer 312, the TaO layer 318, and the liquid-repellent film layer 319. The first SiO₂ layer 312 is formed on the first surface 111a of the substrate 111 in the region K that overlaps with the pressure chamber 105. The TaO layer 318 is formed to overlap the first SiO₂ layer 312 in the region K that overlaps with the pressure chamber 105. The liquid-repellent film layer 319 is formed to overlap the TaO layer 318 in the region K that overlaps with the pressure chamber 105. As described above, the first film 112 may be a single-layer film.

The second film 113 includes the second SiO₂ layer 314, the SiC layer 317, and the TaO layer 318. The second SiO₂ layer 314 is formed on the second surface 111b of the substrate 111 in the other portion K2 of the region K that overlaps with the pressure chamber 105 (refer to FIG. 13B and FIG. 14). The SiC layer 317 is formed on the second surface 111b of the substrate 111 in the proximity portion K1 of the region K that overlaps with the pressure chamber 105 (refer to FIG. 13C and FIG. 14). The SiC layer 317 is formed to overlap the second SiO₂ layer 314 in the other portion K2 of the region K that overlaps with the pressure chamber 105 (refer to FIG. 13B). The TaO layer 318 is formed to overlap the SiC layer 317 in the region K that overlaps with the pressure chamber 105 (refer to FIGS. 13B and 13C). In this manner, the proximity portion (K1) of the second film 113 that is in contact with the nozzle 110 includes the SiC layer 317 and the TaO layer 318. The other portion (K2) of the second film 113 includes the second SiO₂ layer 314, the SiC layer 317, and the TaO layer 318. As described above, the first film 112 is not limited to having three layers, but may have two layers (the first layer 115 and the second layer 116).

It should be noted that the TaO layer 318 is a layer that forms the first film 112 and the second film 113. The TaO layer 318 is formed so as to cover an inner wall surfaces of the nozzle 110, the pressure chamber 105, the individual supply flow path 104, and the individual collecting flow path 108.

In this embodiment, in the region K of the nozzle substrate 101 that overlaps with the pressure chamber 105, the second film 113 including a plurality of layers is formed on the opposite side of the nozzle substrate 101 to the first film 112. The first film 112 includes the first SiO₂ layer 312, the TaO layer 318, and the liquid-repellent film layer 319. The second film 113 includes the second SiO₂ layer 314, the SiC layer 317, and the TaO layer 318. Accordingly, it became possible to offset the tension (the force pulling both end sides of the substrate 111) applied to the substrate 111 (the second Si layer 313) from the first film 112, which was a compressive film, by the tension applied to the substrate 111 from the second film 113, which was a compressive film. In this example, the tension applied to the substrate 111 from the first film 112 was greater than the tension applied to the substrate 111 from the second film 113. Specifically, the magnitude of the tension applied from the first film 112 to the substrate 111 was less than twice the magnitude of the tension applied from the second film 113 to the substrate 111. Therefore, it was possible to suppress the stress generated in the region K of the nozzle substrate 101 that overlapped with the pressure chamber 105, and it was possible to improve the reliability regarding the strength of the nozzle substrate 101.

It should be noted that the magnitude of the tension applied from the first film 112 to the substrate 111 is calculated based on the sum of the products of the compressive stress generated in each layer of the first film 112 (the first SiO₂ layer 312, the TaO layer 318, and the liquid-repellent film layer 319) and the thickness of each layer of the first film 112. The magnitude of the tension applied from the second film 113 to the substrate 111 can be calculated based on the sum of the products of the compressive stress generated in each layer of the second film 113 (the second SiO₂ layer 314, the SiC layer 317, and the TaO layer 318) and the thickness of each layer of the second film 113. In this embodiment, by satisfying the above-described formulas (1) and (2), it was possible to reduce the difference between the tension applied to the substrate 111 from the first film 112 and the tension applied to the substrate 111 from the second film 113.

In addition, the thickness of the proximity portion (K1) of the second film 113 that is in contact with the nozzle 110 is smaller than the thickness of the other portion (K2) of the second film 113 other than the proximity portion (K1). Accordingly, since the proximity portion K1 of the region K of the nozzle substrate 101 that overlapped with the pressure chamber 105 became thinner, it was possible to shorten the length of the nozzles 110 in the ink ejecting direction (the Z direction). Therefore, it was possible to reduce the flow path resistance of the ink in the nozzles 110.

In addition, the proximity portion (K1) of the second film 113 that is in contact with the nozzle 110 is not in contact with the bonding interface 113a of the nozzle substrate 101 (the second film 113). The surface area of the proximity portion (K1) of the second film 113 that was in contact with the nozzle 110 was 5% of the surface area of the other portion (K2) of the second film 113. Accordingly, it was possible to improve the reliability regarding the strength of the nozzle substrate 101.

In the above-described example, the first film 112 is a compressive film including the first SiO₂ layer 312, the TaO layer 318, and the liquid-repellent film layer 319, but is not limited to this. The second film 113 is a compressive film including the second SiO₂ layer 314, the SiC layer 317, and the TaO layer 318, but is not limited to this. For example, in a case where the first film 112 is a tensile film, the second film 113 may be a tensile film. Accordingly, it becomes possible to offset the pressure force (the force pressing on both end sides of the substrate 111) applied to the substrate 111 from the first film 112, which is a tensile film, by the pressure force applied to the substrate 111 from the second film 113, which is a tensile film. In this case, the first film 112 may have a layer of a material different from the first SiO₂ layer, the TaO layer, and the liquid-repellent film layer. The second film 113 may have a layer of a material different from the second SiO₂ layer, the SiC layer, and the TaO layer. The magnitude of the pressing force applied from the first film 112 to the substrate 111 can be calculated based on the sum of the products of the tensile stress generated in each layer of the first film 112 and the thickness of each layer of the first film 112. The magnitude of the pressing force applied from the second film 113 to the substrate 111 can be calculated based on the sum of the products of the tensile stress generated in each layer of the second film 113 and the thickness of each layer of the second film 113.

In the above-described embodiment, the epoxy resin adhesive agent was used as the adhesive agent 103, but the adhesive agent 103 is not limited to this. For example, as the adhesive agent 103, an acrylic resin adhesive agent may be used, or a modified silicone resin adhesive agent may be used. The components of the adhesive agent 103 may include at least one of epoxy resin, acrylic resin, silicone resin, benzocyclobutene resin, polyamide resin, polyimide resin, and urethane resin.

In the above-described example, the order of performing each process of the manufacturing processes of the element substrate 100 is not limited as long as the element substrate 100 can be manufactured. The order of performing each process of the manufacturing processes of the element substrate 100 may be changed as appropriate. Some processes of the manufacturing processes of the element substrate 100 may be performed simultaneously.

As described above, according to the second embodiment, as in the first embodiment, the reliability regarding the strength of the nozzle substrate 101 can be improved. In addition, in the second embodiment, the thickness of the proximity portion (K1) of the second film 113 that is in contact with the nozzle 110 is smaller than the thickness of the other portion (K2) of the second film 113 other than the proximity portion (K1). Accordingly, since the proximity portion K1 of the region K of the nozzle substrate 101 that overlaps with the pressure chamber 105 becomes thinner, the length of the nozzles 110 in the ink ejecting direction (the Z direction) can be shortened. Therefore, the flow path resistance of the ink in the nozzles 110 can be reduced.

In the second embodiment described above, the thickness of the proximity portion (K1) of the second film 113 that is in contact with the nozzle 110 is smaller than the thickness of the other portion (K2) of the second film 113 other than the proximity portion (K1), but this is not a limitation. For example, the thickness of the proximity portion of the first film 112 that is in contact with the nozzle 110 may be smaller than the thickness of the other portion of the first film 112 other than the proximity portion. In this case, the number of layers forming the proximity portion of the first film 112 that is in contact with the nozzle 110 may be less than the number of layers forming the other portion of the first film 112. The surface area of the proximity portion of the first film 112 that is in contact with the nozzle 110 may be 10% or less of the surface area of the other portion of the first film 112.

In each of the above-described embodiments, ink is used as the liquid, but the liquid to which the technologies of the present disclosure can be applied is not limited to ink. For example, a treatment liquid or the like used for the purposes of improving the fixation of ink on a print medium, reducing uneven gloss, and improving abrasion resistance may be used as the liquid.

In each of the above-described embodiments, the piezoelectric element 106 is used as the energy generating element that imparts the energy required for ejecting of the ink (liquid), but this is not a limitation. For example, an electrothermal conversion element may be used as the energy generating element. The electrothermal conversion element may be a heater element capable of heating ink to boiling.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, the reliability regarding the strength of the nozzle substrate can be improved.

This application claims the benefit of Japanese Patent Application No. 2025-036702, filed Mar. 7, 2025, which is hereby incorporated by reference herein in its entirety.

What is claimed is:

1. A liquid ejection head substrate comprising:
a nozzle substrate including a nozzle for ejecting liquid,
the nozzle substrate including:
a substrate in which the nozzle is formed;
a first film provided on a first surface of the substrate on a side from which the liquid is ejected from the nozzle; and
a second film provided on a second surface of the substrate opposite to the first surface,
wherein a compressive stress or tensile stress similar to a compressive stress or tensile stress generated in the first film is generated in the second film.

2. The liquid ejection head substrate according to claim 1, wherein a relationship between a force applied from the first film to the substrate and a force applied from the second film to the substrate is expressed by a formula as follows:
0.5<F1/F2<2
where F1 is a magnitude of the force applied from the first film to the substrate, and
F2 is a magnitude of the force applied from the second film to the substrate.

3. The liquid ejection head substrate according to claim 1, wherein a relationship between a force applied from the first film to the substrate and a force applied from the second film to the substrate is expressed by a formula as follows:

|F1−F2|<=100 [N/m]
where F1 is a magnitude of the force applied from the first film to the substrate, and
F2 is a magnitude of the force applied from the second film to the substrate.

4. The liquid ejection head substrate according to claim 1, wherein the first film includes a plurality of layers.

5. The liquid ejection head substrate according to claim 1, wherein the second film includes a plurality of layers.

6. The liquid ejection head substrate according to claim 4, wherein materials of the plurality of layers are different from each other.

7. The liquid ejection head substrate according to claim 3, wherein in a case where the first film is a single-layer film, a magnitude of the force applied from the first film to the substrate is calculated based on a product of a stress generated in the first film and a thickness of the first film, and
in a case where the first film includes a plurality of layers, the magnitude of the force applied from the first film to the substrate is calculated based on a sum of products of a stress generated in each layer of the first film and a thickness of each layer of the first film.

8. The liquid ejection head substrate according to claim 3, wherein in a case where the second film is a single-layer film, a magnitude of the force applied from the second film to the substrate is calculated based on a product of a stress generated in the second film and a thickness of the second film, and
in a case where the second film includes a plurality of layers, the magnitude of the force applied from the second film to the substrate is calculated based on a sum of products of a stress generated in each layer of the second film and a thickness of each layer of the second film.

9. The liquid ejection head substrate according to claim 1, wherein a thickness of the liquid ejection head substrate is 40 [μm] or less.

10. The liquid ejection head substrate according to claim 1, wherein a thickness of the liquid ejection head substrate is 25 [μm] or less.

11. The liquid ejection head substrate according to claim 1, wherein the first film is formed by using at least one of SiO₂, SiC, TaO, and perfluoropolyether.

12. The liquid ejection head substrate according to claim 1, wherein the second film is formed by using at least one of SiO₂, SiC, TaO, and perfluoropolyether.

13. The liquid ejection head substrate according to claim 1, wherein a thickness of a proximity portion of the first film that is in contact with the nozzle is smaller than a thickness of another portion of the second film other than the proximity portion.

14. The liquid ejection head substrate according to claim 1, wherein a thickness of a proximity portion of the second film that is in contact with the nozzle is smaller than a thickness of another portion of the first film other than the proximity portion.

15. The liquid ejection head substrate according to claim 1, further comprising:
a flow path substrate for supplying liquid to the nozzle,
wherein the second film includes a bonding interface to which the flow path substrate is bonded.

16. The liquid ejection head substrate according to claim 15, wherein a pressure chamber communicating with the nozzle is formed between the second film and the flow path substrate.

17. The liquid ejection head substrate according to claim 16, wherein the liquid supplied to the nozzle circulates through the pressure chamber.

18. The liquid ejection head substrate according to claim 15, wherein components of an adhesive agent for bonding the flow path substrate to the bonding interface include at least one of epoxy resin, acrylic resin, silicone resin, benzocyclobutene resin, polyamide resin, polyimide resin, and urethane resin.

19. The liquid ejection head substrate according to claim 1, wherein the first film and the second film are not arranged in a portion of the first surface and the second surface of the substrate where the nozzle is to be formed.

20. A method of manufacturing a liquid ejection head substrate including a nozzle substrate having a nozzle for ejecting liquid, the method comprising:
preparing a substrate in which the nozzle is to be formed;
forming a first film on a first surface of the substrate on a side from which liquid is ejected from the nozzle; and
forming a second film on a second surface of the substrate opposite to the first surface,
wherein a compressive stress or tensile stress similar to a compressive stress or tensile stress generated in the first film is generated in the second film.
